(19) United States
(12) Patent Application Publication
(10) Pub. No.: US 2026/0352623 A1
(43) Pub. Date: Nov. 5, 2026

(54) USER IDENTITY ALLOCATION FOR DATA COMMUNICATION SERVICES

(71) Applicant: T-MOBILE INNOVATIONS LLC, Overland Park, KS (US)

(72) Inventors: Raymond Emilio Reeves, Oviedo, FL (US); Mark Douglas Peden, Paola, KS (US); Simon Youngs, Overland Park, KS (US); Adrian James Lazar Adler, Seattle, WA (US)

(21) Appl. No.: 19/196,602

(22) Filed: May 1, 2025

(51) Int. Cl. H04L 51/23; H04L 51/48; H04L 65/1104; H04W 4/14

(52) U.S. Cl. CPC H04L 51/23; H04L 51/48; H04L 65/1104; H04W 4/14

(57) ABSTRACT

In some examples, a data system transfers data messages using a user identity. The data system determines whether the data messages are successfully delivered or fail to be delivered. The data system allocates the user identity to the user when the all of the data messages fail to be delivered. The data system identifies another user identity for the user when at least one of the data message is successfully delivered.

### TECHNICAL BACKGROUND

Data systems provide data communication services to user devices like phones, vehicles, robots, and computers. The data services include internet-access, machine-communications, media-streaming, or some other data product. For example, satellite communication networks may exchange text messages between wireless phones. In another example, wireless communication networks may provide video calling between users.

To facilitate these data services, the users and their communication devices are allocated user identities. The data systems use the user identities for user authentication of the user's communication devices and service delivery to these communication devices. The user identities could be numbers, names, codes, images, or some other information that identifies the user and their communication devices. A typical user identity is a telephone number, and other user identities include mobile station international subscriber directory numbers, email addresses, and text messaging short codes. In addition, the user identities may comprise bio-markers like facial pictures, retina scans, fingerprints, and voiceprints.

Due to the proliferation of disparate communication systems like satellite communication systems, Fifth Generation New Radio (5GNR) access networks, and Internet-of-Things (IoT) data portals, some user identities may be inadvertently allocated to multiple users at the same time. This simultaneous allocation of the same user identity to different users can result in a loss-of-service for one or both of the users. In these situations, some communication systems may only serve one of the users at a time, and the other user experiences a loss of data communication service. Some communication systems may even cancel the user identity for one of the users which leads to a complete loss of service for that user.

For example, a data communication system may comprise a wireless Public Land Mobile Network (PLMN) and a landline Internet Service Provider (ISP). A telephone number may be allocated to a first user by the PLMN, and the same telephone number may be allocated to a different user by the ISP. At some point, one of the users is denied data communication service because the telephone number has already been registered and is being used by the other user. When the user that was denied service complains to the data communication system for the loss of data communication service, the data communication system may respond by cancelling the telephone number for the other user. The other user is then left without data communication service.

### TECHNICAL OVERVIEW

In some examples, a data system comprises a user identification system and a data communication system. The user identification system directs the data communication system to transfer a data message using a user identity. The data communication system transfers the data message using the user identity and determines whether the data message is delivered to another user or fails to be delivered. The data communication system informs the user identification system whether the data message is delivered to another user or if the data message fails to be delivered. The user identification system allocates the user identity to the user when the data message fails to be delivered. The user identification system identifies another user identity for the user when the user data message is delivered to the other user.

In some examples, a method comprises the following operations. Identify a user identity. Transfer a data message using the user identity. Allocate the user identity to a user when the data message fails. Identify another user identity for the user when the user data message is successful.

In some examples, a method comprises the following operations. Receive a digital image for a user. Attempt a data communication using the digital image. Allocate the digital image to the user when the attempted data communication fails. Transfer subsequent data communications for the user based on the digital image.

### DESCRIPTION OF THE DRAWINGS

FIG. 1 illustrates an exemplary data system to allocate a user identity to a data communication user.

FIG. 2 comprises a flow diagram that illustrates an exemplary operation of the data system to allocate the user identity to the data communication user.

FIG. 3 comprises a message sequence diagram that illustrates an exemplary operation of the data system to allocate the user identity to the data communication user.

FIG. 4 illustrates an exemplary satellite communication system to allocate a user image to a data communication user.

FIG. 5 illustrates an exemplary wireless communication network to allocate a user telephone number to User Equipment (UE).

FIG. 6 illustrates an exemplary UE in the wireless communication network that allocates the user telephone number to the UE.

FIG. 7 illustrates an exemplary terrestrial Fifth Generation New Radio (5GNR) Access Node (AN) in the wireless communication network that that allocates the user telephone number to the UE.

FIG. 8 illustrates an exemplary Wireless Fidelity (WIFI) AN in the wireless communication network that allocates the user telephone number to the UE.

FIG. 9 illustrates an exemplary Satellite (SAT) AN and SAT Ground Station (GND) in the wireless communication network that allocates the user telephone number to the UE.

FIG. 10 illustrates an exemplary Network Function Virtualization Infrastructure (NFVI) in the wireless communication network that allocates the user telephone number to the UE.

FIG. 11 illustrates an exemplary operation of the wireless communication network to allocate the user telephone number to the UE.

FIG. 12 illustrates exemplary processing circuitry to allocate a user identity to a data communication user.

### DETAILED DESCRIPTION

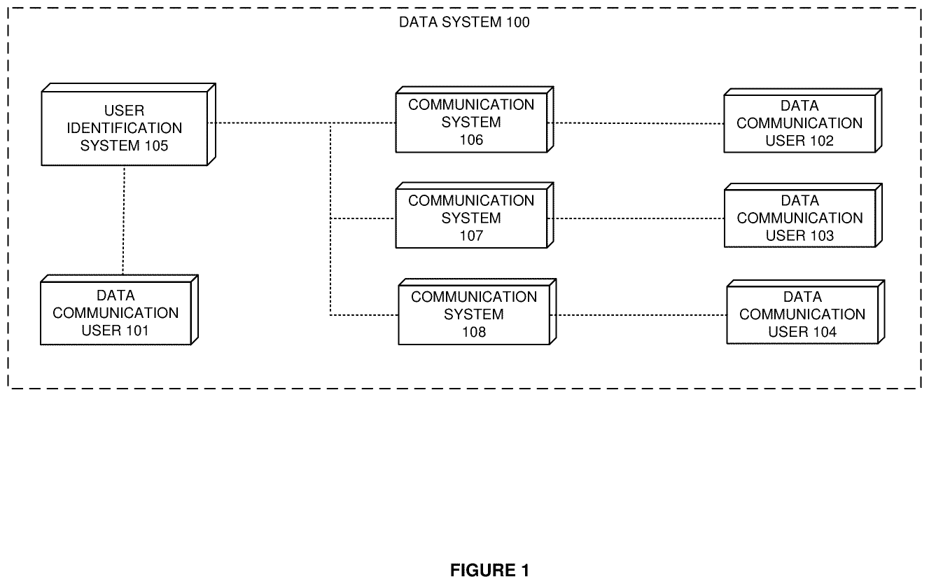

FIG. 1 illustrates exemplary data system 100 to allocate a user identity to data communication user 101. Data system 100 comprises data communication users 101-104, user identification system 105, and communication systems 106-108. Data communication users 101-104 comprise entities that operate data communication equipment like phones, computers, vehicles, robots, and/or some other data apparatus. The entities could be humans or machines. The amount of data communication users depicted on FIG. 1 has been restricted for clarity, and typically, many more data communication users would be configured and operate like data communication users 101-104.

In some examples, user identification system 105 obtains a potential user identity for data communication user 101. User identification system 105 may generate the potential user identity, receive the potential user identity from data communication user 101, or obtain the potential user identity in some other manner. User identification system 105 directs communication systems 106-108 to transfer data messages using the user identity. In response, communication systems 106-108 transfer the data message using the user identity. For example, communication systems 106-108 may each transfer a text message to a potential telephone number for data communication user 101. Communication systems 106-108 determine when any of the data messages are delivered to any of data communication users 102-104 or when all of the data messages fail to be delivered. For example, communication system 106 may receive a text message delivery receipt from data communication user 102. In contrast, a text messaging server in communication system 106 may indicate that the text message is undeliverable due to an unknown destination telephone number. Communication systems 106-108 inform user identification system 105 when one of the data messages is delivered or when all of the data messages fail to be delivered. User identification system 105 allocates the user identity to data communication user 101 when all of the data messages fail to be delivered as this indicates that no other user already has the user identity. User identification system 105 obtains another potential user identity for data communication user 101 when one or more of the data messages are delivered to data communication users 102-104, because this indicates that the user identity is already taken.

The user identity could be a number, name, code, image, audio, or some other information that identifies the user. For example, user identity may comprise a telephone number, mobile station international subscriber directory number, email address, or text messaging short code. Alternatively, the user identity may comprise an image like a facial picture, retina scan, fingerprint, voiceprint, or some other bio-marker.

The data message may comprise a Short Message Service (SMS) message, Multimedia Message Service (MMS) message, Rich Communication Service (RCS) message, Session Initiation Protocol (SIP) message, email, or some other form of information transfer. The data message may be a silent message that triggers the return of a delivery notice but does not alert the receiving data communication user.

Data communication users 101-104, user identification system 105, and communication systems 106-108 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

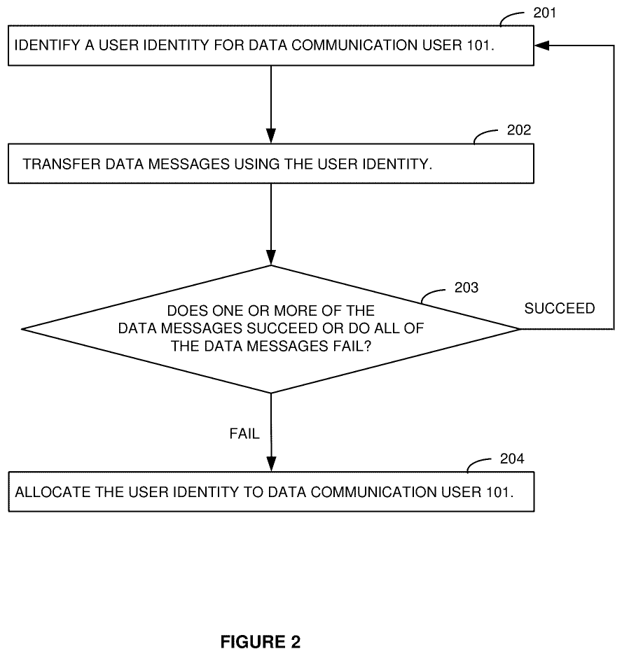

FIG. 2 comprises a flow diagram that illustrates an exemplary operation of data system 100 to allocate the user identity to data communication user 101. The operation may differ in other examples. Identify a user identity for data communication user 101 (201). Transfer data messages using the user identity (202). When all of the data message fail (203), allocate the user identity to data communication user 101 (204). When one or more of the data messages succeed (203), repeat the operation with another user identity (201).

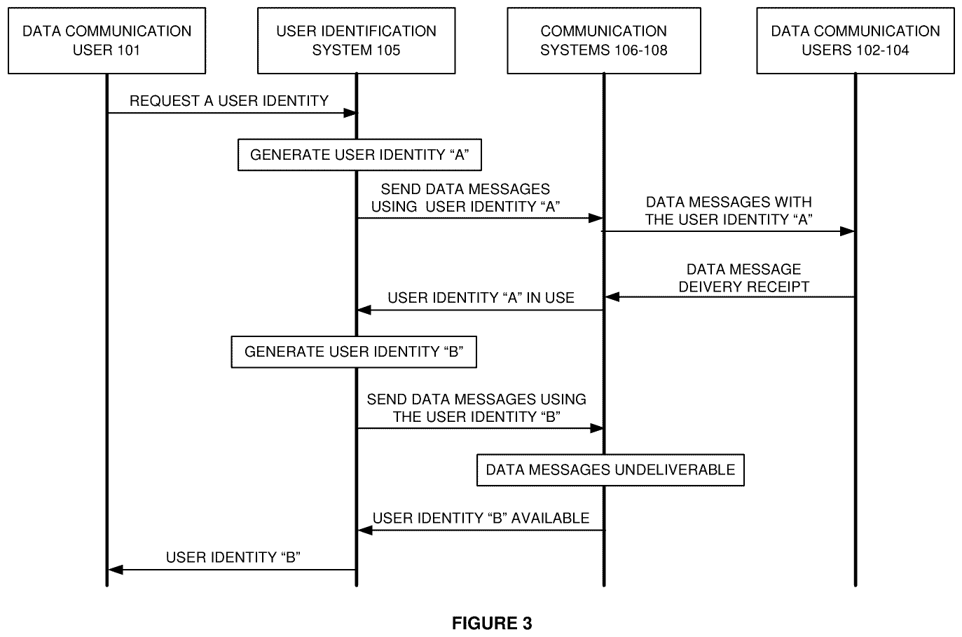

FIG. 3 comprises a message sequence diagram that illustrates an exemplary operation of data system 100 to allocate the user identity to data communication user 101. Data communication user 101 requests a user identity from user identification system 105. User identification system 105 generates potential user identity “A” for data communication user 101. User identification system 105 directs communication systems 106-108 to each transfer a data message using user identity “A”. Communication systems 106-108 each transfer their data message using user identity “A” and one of the data messages is successfully received by one of data communication users 102-104. The receiving one of data communication users 102-104 returns a data message delivery receipt to communication systems 106-108. Communication systems 106-108 inform user identification system 105 that user identity “A” is already being used.

In response to user identity “A” being used, user identification system 105 generates potential user identity “B” for data communication user 101. User identification system 105 directs each of communication systems 106-108 to transfer a data message using user identity “B”. Communication systems 106-108 each transfer their data message using user identity “B” and the data messages are undeliverable and fail. Communication systems 106-108 inform user identification system 105 that user identity “B” is available. In response, user identification system 105 allocates user identity “B” to data communication user 101.

Advantageously, data system 100 effectively allocates user identities. Moreover, data system 100 efficiently avoids duplicate and simultaneous user identities among disparate communication systems that may not share their new user identities in a timely manner.

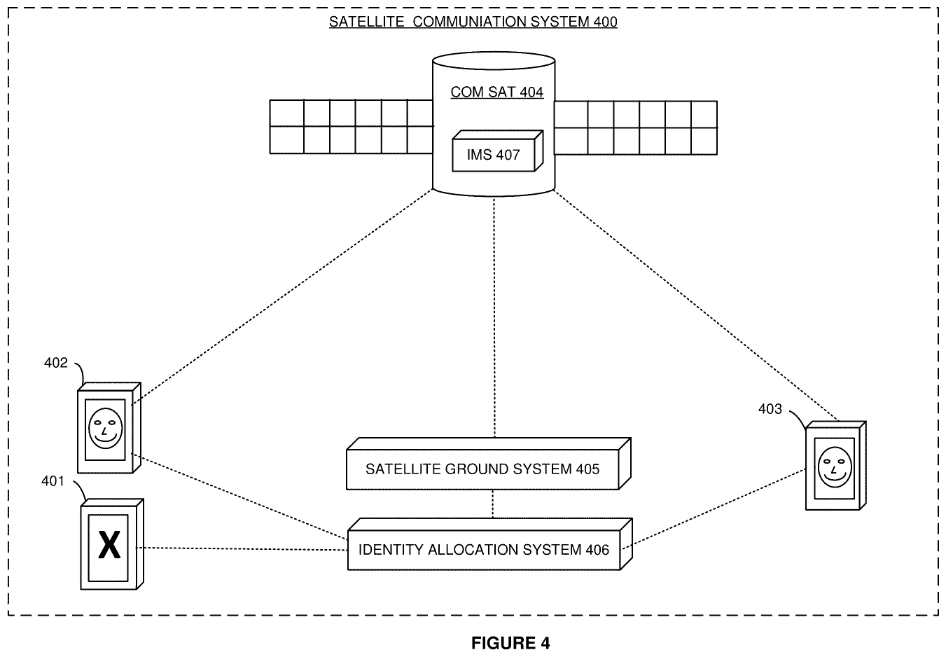

FIG. 4 illustrates exemplary satellite communication system 400 to allocate a user image to a data communication user 402. Wireless data system 400 comprises wireless phones 401-403, communication satellite (COM SAT) 404, satellite ground system 405, and identity allocation system 406. Communication satellite 404 comprises Internet Protocol Multimedia Subsystem (IMS) 407. In this example, a picture of the user's face comprises the user identity but other user images like fingerprints, retina scans, and the like could be used in other examples.

Wireless phone 403 takes a picture of its own user and transfers this true picture to identity allocation system 406. Identity allocation system 406 attempts a video call by transferring a Session Initiation Protocol (SIP) message having the true picture to IMS 407 in communication satellite 404 over satellite ground system 405. In this example, IMS 407 processes the true picture for the video call but cannot identify any associated user communication device. If IMS 407 were to identify an associated user communication device for the true picture, then IMS 407 would have transferred a SIP message for the video call to that user communication device as a test. Since no user communication device was identified in this example, IMS 407 transfers a SIP response for the video call to identity allocation system 406 over satellite ground system 405. The SIP response indicates that the video call failed due to an unidentifiable picture. Identity allocation system 406 responsively allocates the true picture to wireless phone 403. For example, identity allocation system 406 may associate the true picture with wireless phone 403 in an artificial intelligence system or database used by system 400. Identity allocation system 406 transfers the true picture and indicates its association with wireless phone 403 to IMS 407 over satellite ground system 405.

In a like manner, wireless phone 402 takes a picture of its own user and transfers this true picture to identity allocation system 406. Identity allocation system 406 attempts a video call by transferring a SIP message having the true picture to IMS 407 in communication satellite 404 over satellite ground system 405. In this example, IMS 407 processes the true picture for the video call but cannot identify any associated user communication device. If IMS 407 were to identify an associated user communication device for the true picture, then IMS 407 would have transferred a SIP message for the video call to that user communication device as a test. Since no user communication device was identified in this example, IMS 407 transfers a SIP response for the video call to identity allocation system 406 over satellite ground system 405. The SIP response indicates that the video call failed due to an unidentifiable picture. Identity allocation system 406 responsively allocates the true picture to wireless phone 402. Identity allocation system 406 transfers the true picture and indicates its association with wireless phone 402 to IMS 407 over satellite ground system 405.

Wireless phone 401 obtains the picture for wireless phone 402 and improperly transfers this false picture to identity allocation system 406. Identity allocation system 406 attempts a video call by transferring a SIP message having the false picture to IMS 407 in communication satellite 404 over satellite ground system 405. IMS 407 processes the false picture to identify wireless phone 402. IMS 407 transfers the SIP message having the false picture to wireless phone 402—although the false picture may be omitted in some examples. The SIP message may be silent so wireless phone 402 does not alert the user or log a call. IMS 407 receives a SIP response from wireless phone 402 that indicates that the SIP message was received. The SIP response may indicate that this false picture from wireless phone 401 is actually the true picture for wireless phone 402. IMS 407 transfers the SIP response for the video call to identity allocation system 406 over satellite ground system 405. In response to the SIP response, identity allocation system 406 terminates the video call since it was only placed to test the false picture and not to make an actual video call. In response to the SIP response, identity allocation system 406 reports wireless phone 401 and may request a true picture from wireless phone 401.

Wireless phone 401 then obtains the picture for wireless phone 403 and improperly transfers this false picture to identity allocation system 406. Identity allocation system 406 attempts a video call by transferring a SIP message having the false picture to IMS 407 in communication satellite 404 over satellite ground system 405. IMS 407 processes the false picture to identify wireless phone 403. IMS 407 transfers the SIP message having the false picture to wireless phone 403—although the false picture may be omitted in some examples. The SIP message may be silent so wireless phone 403 does not alert the user or log a call. IMS 407 receives a SIP response from wireless phone 403 that indicates that the SIP message was received. The SIP response may indicate that this false picture from wireless phone 401 is actually the true picture for wireless phone 403. IMS 407 transfers the SIP response for the video call to identity allocation system 406 over satellite ground system 405. In response to the SIP response, identity allocation system 406 terminates the video call since it was only placed to test the false picture and not to make an actual video call. In response to the SIP response, identity allocation system 406 reports wireless phone 401 and may request a true picture from wireless phone 401.

Wireless phones 402-403 exchange their true pictures over identity allocation system 406, IMS 407, or some other communication link. Wireless phone 403 attempts a video call to wireless phone 402 by transferring a SIP message having the true pictures for wireless phones 402-403 to IMS 407 in communication satellite 404. IMS 407 processes the true pictures for the video call to identify wireless phones 402-403. IMS 407 transfers the SIP message having the true pictures to wireless phone 402. IMS 407 receives a SIP response from wireless phone 402 that accepts the video call. IMS 407 transfers the SIP response for the video call to wireless phone 403. Wireless phones 402-403 then exchange video and audio for the video call over communication satellite 404.

In some examples, the process described above is performed in parallel with other satellites communication systems. When any of the other satellites communication systems successfully transfer a SIP message for a video call using the picture for wireless phone 402, then the picture is not allocated to wireless phone 402. When none of the other satellite communication systems successfully transfer SIP messages for the video calls using the picture, then the picture is allocated to wireless phone 402.

In some examples, multiple pictures of the same user may be used. For example, wireless phone 402 may take its user's picture and request that this picture as the user identity for wireless phone 402. Wireless phone 403 may then take a picture of its user together with the user of wireless phone 402. Wireless phone 403 may then use this other picture of both users to communicate with wireless phone 402 over IMS 407. IMS 407 may use Artificial Intelligence (AI) to match the user's face from the two pictures to associate wireless phones 402-403.

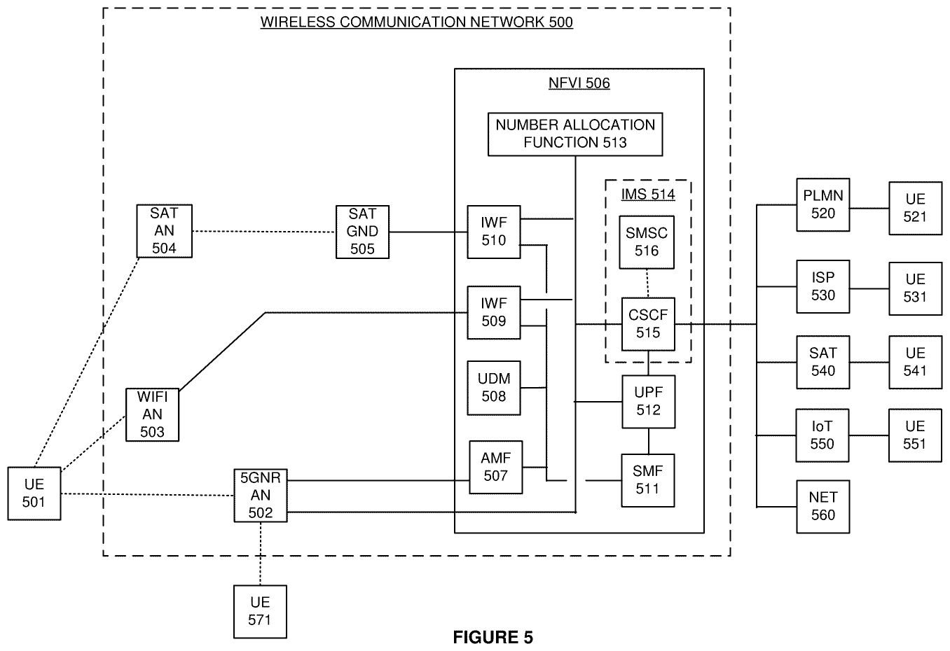

FIG. 5 illustrates exemplary wireless communication network 500 to allocate a user telephone number to User Equipment (UE) 501. Wireless communication network 500 comprises an example of data system 100 and satellite communication system 400, although systems 100 and 400 may differ. Wireless communication network 500 comprises Fifth Generation New Radio Access Node (5GNR AN) 502, Wireless Fidelity Access Node (WIFI AN) 503, Satellite Access Node (SAT AN) 504, Satellite Ground Station (SAT GND) 505, and Network Function Virtualization Infrastructure (NFVI) 506. NFVI 506 comprises Access and Mobility Management Function (AMF) 507, Unified Data Management (UDM) 508, Interworking Functions (IWFs) 509-510, Session Management Function (SMF) 511, User Plane Function (UPF) 512, number allocation function 513, and Internet Protocol Multimedia Subsystem (IMS) 514. IMS 514 comprises Call State Control Function (CSCF) 515 and Short Message Service Center (SMSC) 516.

In operation, a user purchases UE 501 and requests a telephone number. In response, number allocation function 513 identifies a potential telephone number for UE 501 and generates a Session Initiation Protocol (SIP) message having Short Message Service (SMS) message from the originating phone number of number application function 513 to the potential telephone number for UE 501. Number allocation function 513 transfers the SIP/SMS message to SMSC 516 over CSCF 515. The originating telephone number of number application function 513 triggers SMSC 516 to check its own IMS registrations for the potential telephone number. For example, the potential telephone number may belong to UE 571 which has registered with SMSC 516. In this example, the potential telephone number is not registered with SMSC 516.

The originating telephone number of application function 513 also triggers SMSC 516 to broadcast the SMS message to the potential telephone number over multiple different systems. SMSC 516 transfers new SIP messages having the SMS message to CSCF 515 for transfer to Public Land Mobile Network (PLMN) 520, Internet Service Provider (ISP) 530, Satellite Communication System (SAT) 540, Internet-of-Things Network (IoT) 550, and some other communication network (NET) 560. PLMN 520, ISP 530, SAT 540, and NET 560 all return SIP messages to SMSC 516 which indicate that the SMS message is undeliverable due to an unknown destination telephone number. However, IoT 550 delivers the SIP/SMS message to UE 551. The SIP/SMS message may be silent so UE 551 does not alert the user or present the SMS message. UE 551 returns an SMS delivery receipt in a SIP response to IoT 550. IoT 550 returns the SMS receipt in a SIP response to SMSC 516 over CSCF 515. SMSC 516 returns the SMS receipt in the SIP response to number allocation function 513.

Since the SIP response indicates that the initial potential telephone number is already in use by UE 551, number allocation function 513 identifies another potential telephone number for UE 501. Number allocation function 513 generates another SIP message having an SMS message from the originating phone number of number application function 513 to the other potential telephone number. Number allocation function 513 transfers the SIP/SMS message to SMSC 516 over CSCF 515. The originating telephone number of number application function 513 triggers SMSC 516 to check its own registrations for the potential telephone number, but the potential telephone number is not registered with SMSC 516.

The originating telephone number of number application function 513 also triggers SMSC 516 to broadcast the SMS message over multiple different systems. SMSC 516 transfers new SIP messages having the SMS message to CSCF 515 for transfer to PLMN 520, ISP 530, SAT 540, IoT 550, and NET 560. CSCF 515, PLMN 520, ISP 530, SAT 540, IoT 550, and NET 560 all return SIP responses to SMSC 516 over CSCF 515 that indicates the SMS message is undeliverable due to an unknown destination telephone number. Since the other potential telephone number is unused, SMSC 516 returns a SIP response to number allocation function 513 that indicates that the potential telephone number is unused. Number allocation function 513 allocates this unused telephone number to UE 501. Through other links (not shown) the allocated telephone number is registered with PLMN 520, ISP 530, SAT 540, IoT 550, and NET 560 as being handled by wireless communication network 500. Through other links (not shown) the telephone number for UE 501 is provided to UE 531.

UE 501 attaches to 5GNR AN 502. UE 501 registers with AMF 507 over 5GNR AN 502. AMF 507 and UDM 508 interact to perform the registration based on a subscriber profile for UE 501. The subscriber profile indicates a default bearer from UE 501 to CSCF 515. AMF 507 and SMF 512 interact to develop context for UE 501 for the default bearer like network addresses and quality-of-service. SMF 512 transfers the context for UE 501 to UPF 513. AMF 507 transfers the context for UE 501 to 5GNR AN 502. AMF 507 transfers the context for UE 501 to UE 501 over 5GNR AN 502. Based on the context, UE 501 and CSCF 515 interact over 5GNR AN 502 and UPF 513 to register UE 501 and its new telephone number with SMSC 516. SMSC 516 registers the new telephone number for UE 501 with ISP 530. UE 531 transfers a SIP/SMS message to the telephone number of UE 501 to ISP 530. Based on the registration, ISP 530 transfers a SIP message having the SMS message to CSCF 515 which forwards the SIP/SMS message to SMSC 516. SMSC 516 transfers a new SIP message having the SMS message to UE 501 over CSCF 515, UPF 512, and 5GNR AN 502. UE 501 presents the SMS message to its user.

UE 521 requests a new telephone number from PLMN 520. The new telephone number is the same as the telephone number that was recently assigned to UE 501. PLMN 520 sends a SIP message to CSCF 515 that has an SMS message to the telephone number of UE 501. CSCF 515 forwards the SIP/SMS message to SMSC 516. SMSC 516 transfers another SIP message having the SMS message to UE 501 over CSCF 515, UPF 512, and 5GNR AN 502. The SIP/SMS message may be silent so UE 501 does not alert the user or present the SMS message. UE 501 returns an SMS message receipt to SMSC 516 over UPF 512, 5GNR AN 502, and CSCF 515. SMSC 516 forwards the SMS message receipt to PLMN 520 over SCSF 515. In response, PLMN 520 obtains a different telephone number for UE 521.

UE 541 requests a new telephone number from Satellite Communication System (SAT) 540. SAT 540 sends a SIP message to CSCF 515 where the SIP message has an SMS message to the new telephone number. CSCF 515 forwards the SIP message to SMSC 516. SMSC 516 does not have any UE registered with the new telephone number, so it returns a SIP response to SAT 540 over CSCF 515 which indicates the SMS message is undeliverable due to an unknown telephone number. SAT 540 allocates the new telephone number to UE 541.

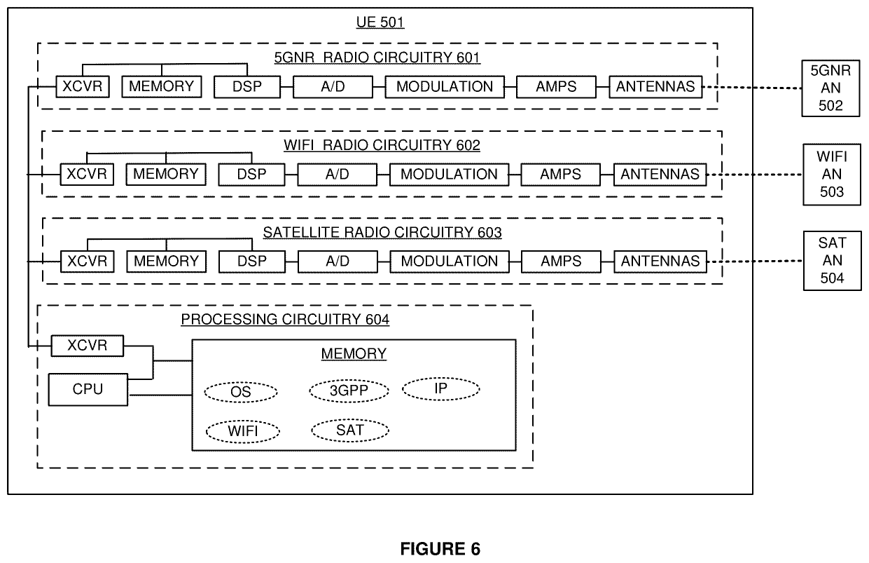

FIG. 6 illustrates an exemplary User Equipment (UE) 501 in wireless communication network 500 that allocates the user telephone number to UE 501. UE 501 comprises an example of data communication users 101-102 and wireless phones 401-403, although users 101-102 and phones 401-403 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 3GPP Application (3GPP), WIFI Application (WIFI), Satellite Application (SAT), and Internet Protocol Application (IP). The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. In particular, the 3GPP application returns a delivery receipt for an SMS message received in a SIP message. The SMS message could be silent so the user is not alerted or presented with the SMS message.

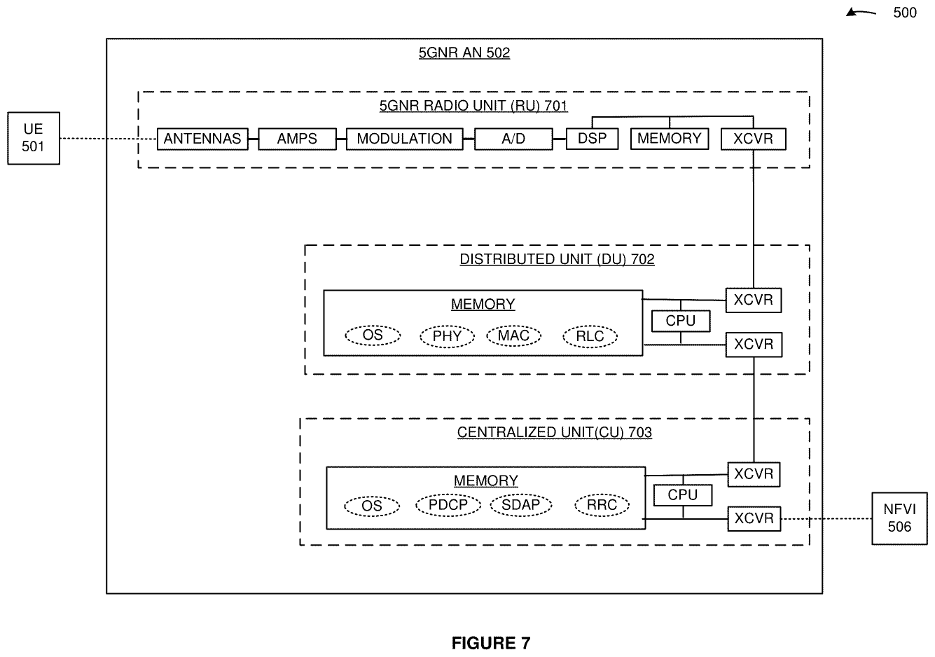

FIG. 7 illustrates an exemplary terrestrial 5GNR AN 502 in the wireless communication network 500 that that allocates the user telephone number to UE 501. 5GNR AN 502 comprises an example of communication systems 106-108 and satellite ground system 405, although systems 104 and 405 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UEs 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein.

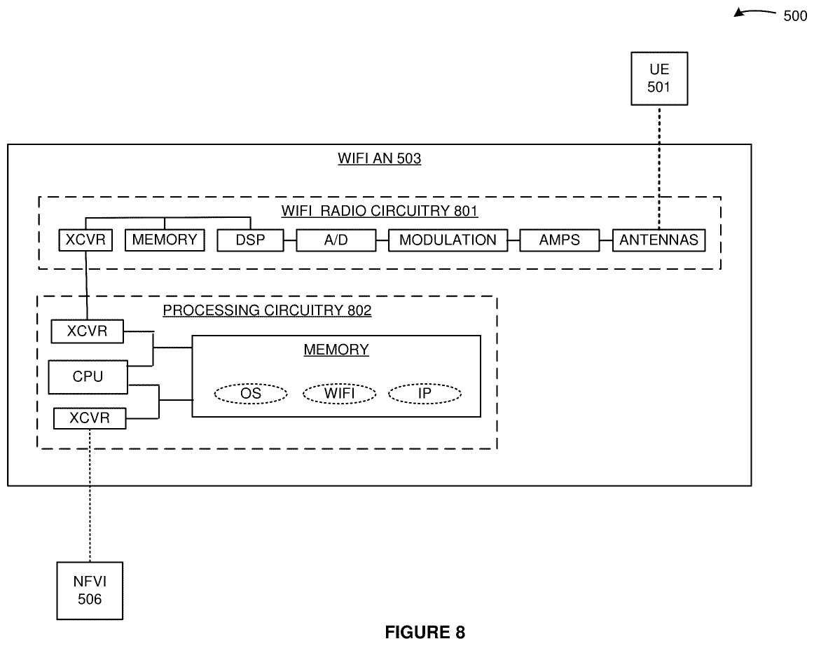

FIG. 8 illustrates an exemplary Wireless Fidelity (WIFI) AN 503 in wireless communication network 500 that allocates the user telephone number to the UE 501. WIFI AN 503 comprises an example of communication systems 106-108 and satellite ground system 405, although systems 104 and 405 may differ. WIFI AN 503 comprises WIFI radio circuitry 801 and processing circuitry 802. WIFI radio circuitry 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio circuitry 801 exchange WIFI signals with UE 501. Transceivers in WIFI radio circuitry 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein.

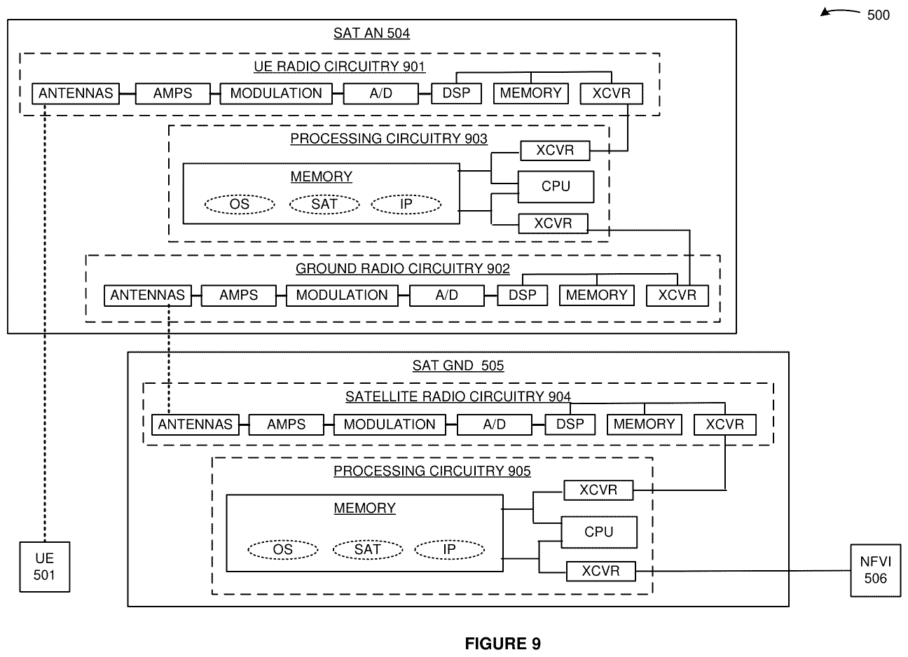

FIG. 9 illustrates an exemplary Satellite (SAT) AN 504 and SAT Ground Station (GND) 505 in wireless communication network 500 that allocates the user telephone number to UE 501. SAT AN 504 and SAT GND 505 comprises an example of communication systems 106-108, communication satellite 404, and satellite ground system 405, although systems 104 and 405 and satellite 404 may differ. SAT AN 504 comprises UE radio 901, ground radio 902, and processing circuitry 903. SAT GND 505 comprises satellite radio circuitry 904 and processing circuitry 905. Radio circuitry 901-902 and 904 comprise antennas, amplifiers, filters, modulation, analog-to-digital interfaces, DSPs, memories, transceivers, and power supplies that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio circuitry 901 exchange satellite signals with UE 501. Transceivers in UE radio circuitry 901 are coupled to transceivers in processing circuitry 903. Transceivers in processing circuitry 903 are coupled to transceivers in ground radio circuitry 902. The antennas in ground radio circuitry 902 exchange satellite signals with antennas in satellite radio circuitry 904, and the antennas in satellite radio circuitry 904 exchange the satellite signals with ground radio circuitry 902. Transceivers in satellite radio circuitry 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UEs 501 and NFVI 506 as described herein.

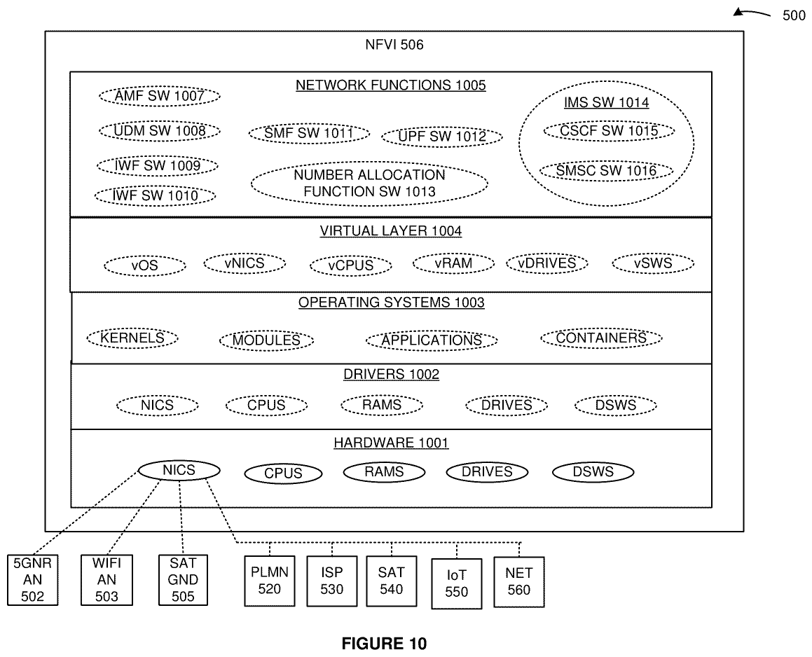

FIG. 10 illustrates exemplary Network Function Virtualization Infrastructure (NFVI) 506 in wireless communication network 500 that allocates the user telephone number to UE 501. NFVI 506 comprises an example of user identification system 105, communication systems 106-108, and identity allocation system 406, although systems 103, 104, and 406 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF Software (SW) 1007, UDM SW 1008, IWF SW 1009-1010, SMF SW 1011, UPF SW 1012, number allocation function SW 1013, and IMS SW 1014. IMS SW 1014 comprises CSCF SW 1015 and SMSC SW 1016. The NICS in hardware 1001 are coupled to ANs 502-503, SAT GND 505, PLMN 520, ISP 530, SAT 540, IoT 550, and NET 560. Hardware 1001 executes hardware drivers 1002, operating systems 1003, virtual layer 1004, and network functions 1005 to form and operate AMF 507, UDM 508, IWFs 509-510, SMF 511, UPF 512, number allocation function 513, IMS 514, CSCF 515, and SMSC 516 as described herein. NFVI 506 may be located at a single site or be distributed across multiple geographic areas.

In particular, number allocation function SW 1013 generates new telephone numbers and directs SMSC SW 1016 to check its own registration for the new telephone numbers and to send SIP messages with SMS messages directed the new telephone numbers to various destinations. Number allocation SW 1013 issues the new telephone number when the new telephone numbers are not registered with SMSC SW 1016 and when no SIP response is received with an SMS delivery receipt.

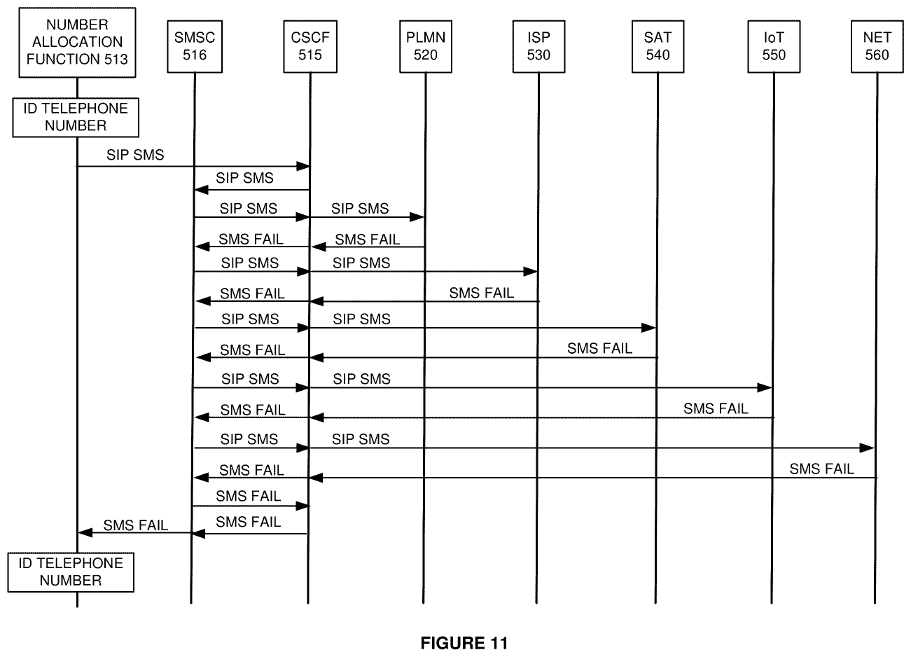

FIG. 11 illustrates an exemplary operation of wireless communication network 500 to allocate the user telephone number to UE 501. The operation may vary in other examples. Number allocation function 513 identifies a potential telephone number for UE 501. Number allocation function 513 transfers a SIP message having an SMS message to the new telephone number to SMSC 516 over CSCF 515. The SMS message is from the originating telephone number of number allocation function 513, and in response, SMSC 516 will transfer the SMS message to multiple systems to test the potential telephone number. SMSC 516 transfers a SIP/SMS message having the new telephone number to PLMN 520 over CSCF 515. PLMN 510 does not have any UE with the potential telephone number and returns a SIP message with an SMS telephone number fail indication to SMSC 516 over CSCF 515. SMSC 516 transfers a SIP/SMS message having the new telephone number to ISP 530 over CSCF 515. ISP 530 does not have any UE with the potential telephone number and returns a SIP message with an SMS telephone number fail indication to SMSC 516 over CSCF 515. SMSC 516 transfers a SIP/SMS message having the new telephone number to SAT 540 over CSCF 515. SAT 540 does not have any UE with the potential telephone number and returns a SIP message with an SMS telephone number fail indication to SMSC 516 over CSCF 515. SMSC 516 transfers a SIP/SMS message having the new telephone number to IoT 550 over CSCF 515. IoT 550 does not have any UE with the potential telephone number and returns a SIP message with an SMS telephone number fail indication to SMSC 516 over CSCF 515. SMSC 516 transfers a SIP/SMS message having the new telephone number to NET 560 over CSCF 515. NET 560 does not have any UE with the potential telephone number and returns a SIP message with an SMS telephone number fail indication to SMSC 516 over CSCF 515. SMSC 516 transfers a SIP message with the SMS telephone number fail indication to number allocation function 513 over CSCF 515. Number allocation function 516 issues the telephone number to UE 501 since no SMS message was delivered using the telephone number. If one of the SMS messages was delivered using the telephone number, then number allocation function 513 would have repeated the process with another potential telephone number.

Advantageously, wireless communication network 500 effectively allocates user telephone numbers. Moreover, wireless communication network 500 efficiently avoids duplicate and simultaneous user telephone numbers among disparate communication systems that do not share new user telephone numbers in a timely manner.

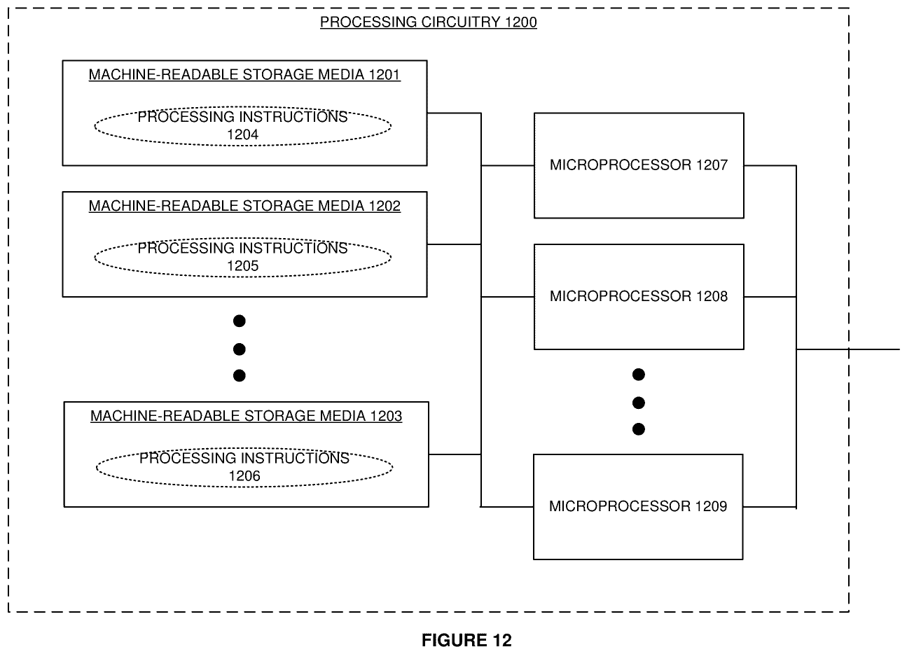

FIG. 12 illustrates exemplary processing circuitry 1200 to allocate a user identity to a data communication user. Processing circuitry 1200 comprises an example of data system 100, wireless data system 400, and wireless communication network 500, although systems 100 and 400 and network 500 may differ. Processing circuitry 1200 comprises machine-readable storage media 1201-1203 and microprocessors 1207-1209 that are communicatively coupled. Machine-readable storage media 1201-1203 store processing instructions 1204-1206 in a non-transitory manner. Microprocessors 1207-1209 comprise DSPs, CPUs, GPUs, ASICs, and/or some other data processing hardware. Machine-readable storage media 1201-1203 comprises RAM, flash circuitry, disk drives, and/or some other type of data storage apparatus. Microprocessors 1207-1209 retrieve processing instructions 1204-1206 from non-transitory machine-readable storage media 1201-1203. Microprocessors 1207-1209 execute processing instructions 1204-1206 to issue new user identities as described above. The amount of storage media, microprocessors, processing instructions that are shown in FIG. 12 may vary in other examples.

The wireless communication system circuitry described above comprises computer hardware and software that form special-purpose data communication circuitry to allocate a user identity to a data communication user. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to allocate a user identity to a data communication user.

The descriptions and figures herein depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
identifying a user identity for a user;
transferring data messages using the user identity;
allocating the user identity to the user when all of the data messages fail; and
identifying another user identity for the user when at least one of the data messages is successful.

2. The method of claim 1 wherein:
transferring the data messages using the user identity comprises transferring text messages using the user identity;
allocating the user identity to the user when all of the data messages fail comprises allocating the user identity to the user when all of the text messages fail; and
identifying the other user identity for the user when the at least one of the data messages is successful comprises identifying the other user identity for the user when at least one of the text messages is successful.

3. The method of claim 1 wherein:
identifying the user identity comprises identifying a telephone number;
transferring the data messages using the user identity comprises transferring the data messages using the telephone number;
allocating the user identity to the user comprises allocating the telephone number to the user; and
identifying the other user identity for the user comprises identifying another telephone number for the user.

4. The method of claim 1 wherein:
identifying the user identity comprises identifying a mobile station international subscriber directory number;
transferring the data messages using the user identity comprises transferring the data messages using the mobile station international subscriber directory number;
allocating the user identity to the user comprises allocating the mobile station international subscriber directory number to the user; and
identifying the other user identity for the user comprises identifying another mobile station international subscriber directory number for the user.

5. The method of claim 1 wherein:
identifying the user identity comprises identifying an email address;
transferring the data message using the user identity comprises transferring the data message using the email address;
allocating the user identity to the user comprises allocating the email address to the user; and
identifying the other user identity for the user comprises identifying another email address for the user.

6. The method of claim 1 wherein:
identifying the user identity comprises identifying a text messaging short code;
transferring the data message using the user identity comprises transferring the data message using the text messaging short code;
allocating the user identity to the user comprises allocating the text messaging short code to the user; and
identifying the other user identity for the user comprises identifying another text messaging short code for the user.

7. The method of claim 1 wherein
transferring the data messages using the user identity comprises transferring text messages using a telephone number;
allocating the user identity to the user when all of the data messages fail comprises allocating the telephone number to the user when all of the text messages fail; and
identifying the other user identity for the user when the at least one of the data messages is successful comprises identifying another telephone number for the user when at least one of the text messages is successful.

8. A method comprising:
receiving a digital image for a user;
attempting a data communication using the digital image;
allocating the digital image to the user when the attempted data communication fails; and
transferring subsequent data communications for the user based on the digital image.

9. The method of claim 8 wherein the digital image comprises a picture of the user.

10. The method of claim 8 wherein attempting the data communication using the digital image comprises transferring a data message having the digital image to a communication satellite.

11. The method of claim 8 wherein attempting the data communication using the digital image comprises transferring a Session Initiation Protocol (SIP) message having the digital image.

12. The method of claim 8 wherein:
attempting the data communication comprises attempting a video call;
allocating the digital image to the user when the attempted data communication fails comprises allocating the digital image to the user when the video call fails; and
transferring the subsequent data communications for the user based on the digital image comprises transferring subsequent video communications for the user based on the digital image.

13. A data system comprising:
a user identification system to direct communication systems to transfer data messages using a user identity;
the communication systems to transfer the data messages using the user identity, determine when the data messages are successfully delivered, and determine when the data messages fail to be delivered;
the communication systems to inform the user identification system when the at least one of the data messages is successfully delivered and when all of the data messages fail to be delivered; and
the user identification system to allocate the user identity to the user when all of the data messages fail to be delivered and to identify another user identity for the user when at least one of the data messages is successfully delivered.

14. The data system of claim 13 wherein the user identity comprises a telephone number.

15. The data system of claim 13 wherein the user identity comprises a mobile station international subscriber directory number.

16. The data system of claim 13 wherein the user identity comprises an email address.

17. The data system of claim 13 wherein the user identity comprises a text messaging short code.

18. The data system of claim 13 wherein at least some of the data messages comprise Short Message Service (SMS) messages.

19. The data system of claim 13 wherein at least some of the data messages comprise Multimedia Message Service (MMS) messages.

20. The data system of claim 13 wherein at least some of the data messages comprise Rich Communication Service (RCS) messages.
